(19) United States
(12) Patent Application Publication
(10) Pub. No.: US 2025/0096575 A1
(43) Pub. Date: Mar. 20, 2025

(54) High voltage ride-through method for wind power based on coordinated control of energy storage and reactive compensation devices

(71) Applicant: STATE GRID XINJIANG ELECTRIC POWER CO., LTD. ELECTRIC POWER RESEARCH INSTITUTE, Urumqi (CN)

(72) Inventors: Qingxi DUAN, Urumqi (CN); Zhen LIU, Urumqi (CN); Yanhui QIN, Urumqi (CN); Yu DUAN, Urumqi (CN); Zimin ZHU, Urumqi (CN); Xiaoyun WANG, Urumqi (CN); Xing MA, Urumqi (CN); Dongliang NAN, Urumqi (CN); Lu ZHANG, Urumqi (CN); Bing SUN, Urumqi (CN); Zhijie LI, Urumqi (CN); Junyi TANG, Urumqi (CN); Jian MA, Urumqi (CN); Weihong ZAO, Urumqi (CN)

(73) Assignee: STATE GRID XINJIANG ELECTRIC POWER CO., LTD. ELECTRIC POWER RESEARCH INSTITUTE, Urumqi (CN)

(21) Appl. No.: 18/887,440

(22) Filed: Sep. 17, 2024

(30) Foreign Application Priority Data
Sep. 19, 2023 (CN) 202311209235.7

(51) Int. Cl. H02J 3/38; H02J 3/00; H02J 3/16; H02J 3/28

(52) U.S. Cl. CPC H02J 3/38; H02J 3/0012; H02J 3/16; H02J 3/28; H02J 2300/28

(57) ABSTRACT

The present invention provides a high voltage ride-through method for wind power based on coordinated control of energy storage and reactive compensation devices, comprising fault determination based on voltages of grid connection points of wind farms; setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults; calculating reactive power shortage of grid connection points under faults based on the control strategies; and determining whether the reactive power shortage of grid connection points is within wind farm regulation ranges and implement corresponding control strategies to adjust voltages based on the reactive power shortage; and determining whether to utilize static var generators to compensate reactive power based on reactive power compensation of doubly-fed induction generators according to deviations between adjusted voltages and steady-state values. The high voltage ride-through method for wind power based on coordinated control of energy storage and reactive compensation devices provided by the present invention can improve the high voltage ride-through capability of wind farms.

### CROSS-REFERENCE TO RELATED APPLICATIONS

This application claims the benefit of priority from China Patent Application No. 202311209235.7 filed on Sep. 19, 2023, the contents of which are hereby incorporated by reference in their entirety.

### TECHNICAL FIELD

The present invention relates to the technical field of high voltage ride-through capability of wind farms, and more particularly to a high voltage ride-through method for wind power based on coordinated control of energy storage and reactive compensation devices.

### BACKGROUND TECHNOLOGY

The proportion of new energy sources connected to the grids, represented by wind energy, is continuously increasing, gradually replacing traditional fossil fuels. The rapid development of wind power is leading to a relatively weak DC system in the power grid. Under DC (Direct Current) faults, transient overvoltage issues become prominent, and the risk of wind turbine generator systems near DC areas disconnecting from the grids increases. Therefore, it is of great significance to fully leverage reactive power regulation equipment within wind farms to enhance their voltage and reactive power regulation capabilities and to develop corresponding coordinated control strategies.

In the prior art, reactive power regulation limits of wind turbine generator systems have been improved, which however is achieved at the expense of reducing active power outputs, and the reactive power output of wind turbine generator systems is increased without considering the coordinated control problems after adding reactive power compensation devices. Therefore, it is necessary to design a high voltage ride-through method for wind power based on coordinated control of energy storage and reactive compensation devices.

### SUMMARY OF THE INVENTION

The purpose of the present invention is to provide a high voltage ride-through method for wind power based on coordinated control of energy storage and reactive compensation devices, which makes full use of the active power leveling capability of energy storage systems and considers the coordinated control capability after adding reactive power compensation devices, thereby enhancing the high voltage ride-through capability of wind farms.

In order to achieve above purposes, the present invention provides following technical solutions:

A high voltage ride-through method for wind power based on coordinated control of energy storage and reactive compensation devices comprises following steps:
step 100: fault determination based on voltages of grid connection points of wind farms;
step 200: setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults;
step 300: calculating reactive power shortage of grid connection points under faults based on the control strategies;
step 400: determining whether the reactive power shortage of grid connection points is within wind farm regulation ranges and implement corresponding control strategies to adjust voltages based on the reactive power shortage; and
step 500: determining whether to utilize static var generators to compensate reactive power based on reactive power compensation of doubly-fed induction generators according to deviations between adjusted voltages and steady-state values.

Preferably, the step 200 of setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults, specifically comprises:
setting voltage fluctuation thresholds of grid connection points under faults, and determining whether grid connection point voltages under faults are greater than the voltage fluctuation thresholds, if so, implementing coordinated control strategies, and if not, not implementing coordinated control strategies.

Preferably, the step 400 of determining whether the reactive power shortage of grid connection points is within wind farm regulation ranges and implement corresponding control strategies to adjust voltages based on the reactive power shortage, specifically comprising: determining whether the reactive power shortage of grid connection points under faults is less than a sum of reactive power limits of doubly-fed induction generators under constant active power outputs and reactive power limits of super capacitor-side converters, if so, implementing improved control strategies for energy storage systems to adjust voltages; if not, then utilizing static var generators to compensate for differences and adjust voltages, and re-determining whether there is a need to implement the coordinated control strategies.

Preferably, the improved control strategies comprise: dividing grid-tie inverters into following two operating modes:
a first mode: during steady-state operation, high voltage ride-through modules take no action, active power output by super capacitors is equal to active power of converters when losses of converters are negligible, reference values of q-axis components of currents flowing from converters to grids are zero, and no reactive power exchange is performed with grids; and
a second mode: when a fault occurs, a high voltage ride-through operation mode is entered and works in an inductive reactive power compensation state, so that reactive power regulation capability of wind farms is utilized and active power stabilization function of super capacitors are leveraged, wherein active power setting values of super capacitors and converters are minimum values of maximum active power absorbed by systems, and reactive power reference values output from converters depend on reactive power regulation limits of wind farms.

Preferably, the step 500 of determining whether to utilize static var generators to compensate reactive power based on reactive power compensation of doubly-fed induction generators according to deviations between adjusted voltages and steady-state values, specifically comprises:
calculating absolute values of differences between real-time measured voltages of grid connection points and steady-state voltages of grid connection points, and determining whether the absolute values of differences are greater than 0.2, if not, using doubly-fed induction generators to compensate for differences in reactive power, if yes, first using the static var generators to compensate until the absolute values of differences between real-time measured voltages of grid connection points and steady-state voltages of grid connection points are less than or equal to 0.2, and then using doubly-fed induction generators to compensate for differences in reactive power.

According to specific embodiments provided by the present invention, the present invention achieves following technical effects: the present invention provides a high voltage ride-through (HVRT) method for wind power based on coordinated control of energy storage and reactive compensation devices, comprising: fault determination based on voltages of grid connection points of wind farms; setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults; calculating reactive power shortage of grid connection points under faults based on the control strategies; determining whether the reactive power shortage of grid connection points is within wind farm regulation ranges and implement corresponding control strategies to adjust voltages based on the reactive power shortage; and determining whether to utilize static var generators to compensate reactive power based on reactive power compensation of doubly-fed induction generators according to deviations between adjusted voltages and steady-state values. The method of the present invention makes full use of the active power leveling capability of energy storage systems while considering the coordinated control capability after integrating reactive compensation devices, so as to enhance the high voltage ride-through capability of wind farms.

### BRIEF DESCRIPTION OF THE DRAWINGS

To better clarify embodiments of the present invention or the technical solutions in the prior art, a brief introduction of drawings required for the embodiments is provided below. It is apparent that the drawings described below are only some embodiments of the present invention. For those skilled in the art, other drawings may be derived from these drawings without creative efforts.

FIG. 1 is a flow chart of a high voltage ride-through method for wind power based on coordinated control of energy storage and reactive compensation devices provided by an embodiment of the present invention.

FIG. 2 is an equivalent diagram of an AC (Alternating Current) system after a DC fault provided by an embodiment of the present invention.

FIG. 3 is a diagram of a rotor-side converter control system provided by an embodiment of the present invention.

FIG. 4 is a technical requirement curve for high voltage ride-through of a wind turbine generator system provided by an embodiment of the present invention.

FIG. 5 is a simplified schematic diagram of a static var generator provided by an embodiment of the present invention.

FIG. 6 is a simplified schematic diagram of a super capacitor provided by an embodiment of the present invention.

FIG. 7 is a static var generator control system diagram provided by an embodiment of the present invention.

FIG. 8 is a super capacitor control system diagram provided by an embodiment of the present invention.

FIG. 9 is a power operation range diagram of super capacitor-side converters provided by an embodiment of the present invention.

FIG. 10 is a voltage regulation range diagram of super capacitor-side converters provided by an embodiment of the present invention.

FIG. 11 is a converter control system diagram in an improved energy storage system provided by an embodiment of the present invention.

FIG. 12 is a super capacitor, static var generator and doubly-fed induction generator coordinated control strategy provided by an embodiment of the present invention.

FIG. 13 is a wiring diagram of a wind farm simulation model provided by an embodiment of the present invention.

FIG. 14 is a voltage detection curve of grid connection points when voltage surge of grid connection points is small provided by an embodiment of the present invention.

FIG. 15 is a super capacitor active power change curve when voltage surge of grid connection points is small provided by an embodiment of the present invention.

FIG. 16 shows changes of charge of state of super capacitors when voltage surge of grid connection points is small provided by an embodiment of the present invention.

FIG. 17 shows changes of reactive power emitted by static var generators when voltage surge of grid connection points is small provided by an embodiment of the present invention.

FIG. 18 shows changes of reactive power of doubly-fed induction generators when voltage surge of grid connection points is small provided by an embodiment of the present invention.

FIG. 19 is a voltage detection curve of grid connection points when voltage surge of grid connection points is large provided by an embodiment of the present invention.

FIG. 20 is a reactive power change curve of static var generators when the voltage surge of grid connection points is large provided by an embodiment of the present invention.

FIG. 21 shows changes of charge of state of super capacitors curve when voltage surge of grid connection points is large provided by an embodiment of the present invention.

FIG. 22 shows changes of active power of super capacitors when voltage surge of grid connection points is large provided by an embodiment of the present invention.

### SPECIFIC EMBODIMENTS

The purpose of the present invention is to provide a high voltage ride-through method for wind power based on coordinated control of energy storage and reactive compensation devices, which makes full use of the active power leveling capability of energy storage systems and considers the coordinated control capability after adding reactive power compensation devices, thereby enhancing the high voltage ride-through capability of wind farms.

In order to make the above-mentioned objects, features and advantages of the present invention more obvious and easy to understand, the present invention is further described in detail below in conjunction with the accompanying drawings and specific embodiments.

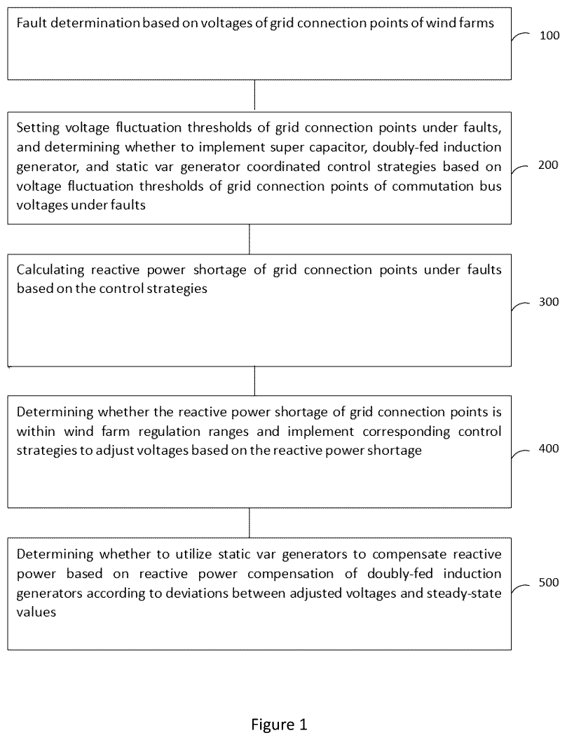

As shown in FIG. 1, an embodiment of the present invention provides a high voltage ride-through method for wind power based on coordinated control of energy storage and reactive compensation devices, comprising following steps:
step 100: fault determination based on voltages of grid connection points of wind farms;
step 200: setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults;
step 300: calculating reactive power shortage of grid connection points under faults based on the control strategies;
step 400: determining whether the reactive power shortage of grid connection points is within wind farm regulation ranges and implement corresponding control strategies to adjust voltages based on the reactive power shortage; and
step 500: determining whether to utilize static var generators to compensate reactive power based on reactive power compensation of doubly-fed induction generators according to deviations between adjusted voltages and steady-state values.

The step 200 of setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults, specifically comprises:
setting voltage fluctuation thresholds of grid connection points under faults, and determining whether grid connection point voltages under faults are greater than the voltage fluctuation thresholds, if so, implementing coordinated control strategies, and if not, not implementing coordinated control strategies.

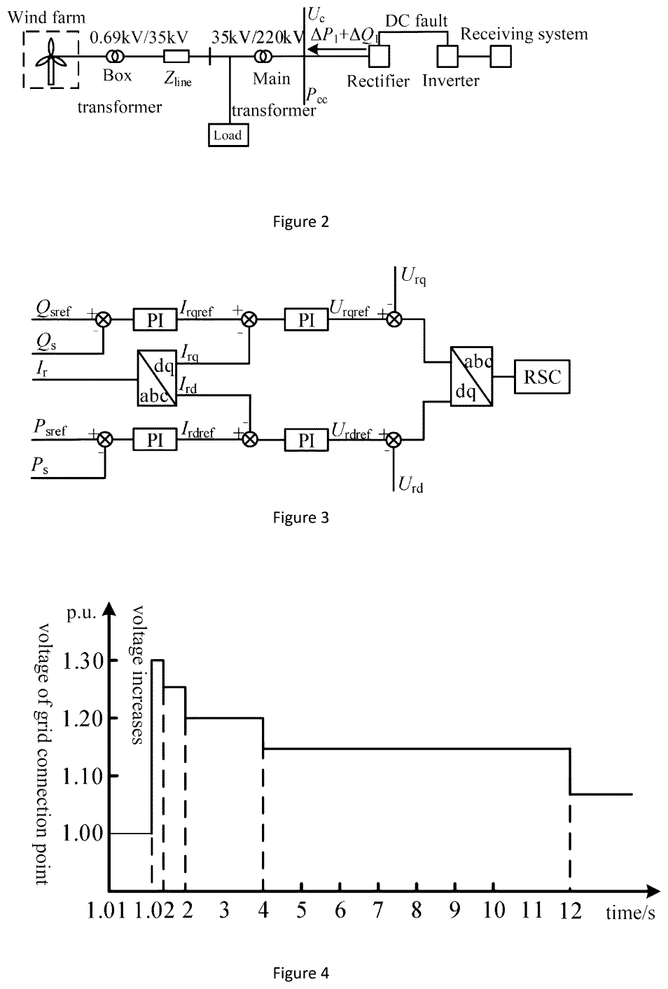

The present invention provides an embodiment to first analyze the mechanism of wind turbine generator disconnection caused by DC faults. An equivalent diagram of an AC system after a DC fault is shown in FIG. 2. In actual power grid operation, when a DC system fails (commutation failure or DC lockout), the active power and reactive power of the DC system will increase significantly, thereby breaking the power balance of the system, and a large amount of active power and reactive power imbalance will be fed into the AC system, wherein voltage of grid connection point in FIG. 2 is expressed as follows:

$${U}_{c} = \sqrt{{( 1 + \frac{Δ {Q}_{1}}{{SCRP}_{d}} )}^{2} + {( \frac{Δ {P}_{1}}{{SCRP}_{d}} )}^{2}} , \qquad ( 1 )$$

where U_{c} refers to voltage of grid connection point; ΔP₁ is active power imbalance of DC system; ΔQ is reactive power imbalance of DC system. P_{d} is rated active power transmission of DC system, and SCR is short circuit ratio;
when the short circuit ratio (SCR) is constant, as unbalanced active power and reactive power within the AC system increase, the transient overvoltage of the commutation bus on the rectifier side will surge sharply; for the sending end with large-scale new energy grid connection, the reactive power surplus caused by the DC system fault is the main cause of the transient overvoltage surge on the rectifier side; and
when a DC system fault causes a sudden surge in transient overvoltage on the rectifier side, a doubly-fed induction generator (DFIG) needs to generate inductive reactive power to suppress the increase in the voltage of grid connection point.

The range of reactive power generated by the doubly-fed induction generator is:

$${Q}_{dfigmin} ⩽ {Q}_{dfig} ⩽ {Q}_{dfigmax} , \qquad ( 2 )$$

where Q_{dfigmax} and Qₛₘₐₓ are lower and upper limits of reactive power output by DFIG;

$$\{ \begin{matrix}{Q}_{dfigmin} = {Q}_{smin} - \sqrt{{S}_{gmax}^{2} - {( {sP}_{s} )}^{2}} \\ {Q}_{dfigma x} = {Q}_{smax} + \sqrt{{S}_{gmax}^{2} - {( {sP}_{s} )}^{2}}\end{matrix} , \qquad ( 3 )$$

where Qₛₘᵢₙ and Qₛₘₐₓ are lower and upper limits of reactive power output on a stator side of DFIG;
a rotor-side converter uses vector control technology to decouple active and reactive power generated by the generator, and its control is shown in FIG. 3;
in FIG. 3, Qₛ, Iᵣ and Pₛ respectively are measured reactive power value of a stator of DFIG, measured value of a rotor current, and measured active power of the stator, Q_{ref}, P_{ref}, I_{rqref}, I_{rdref}, U_{rqref} and U_{rdref} are reactive power reference value of the stator, active power reference value of the stator, q-axis component reference value of a rotor, d-axis component reference value of the rotor, q-axis component reference value of the rotor, d-axis component reference value of the rotor, respectively, I_{rq} and I_{rd} are q-axis and d-axis components of the rotor respectively; and
in addition, a control system of a grid-side converter is similar to that of a static var generator (SVG) and will not be discussed in detail.

According to the Chinese national standard “Testing Procedures for High Voltage Ride-Through of Wind Turbines,” the technical requirements for high voltage ride-through (HVRT) of a wind turbine generator system are shown in FIG. 4.

In FIG. 4, a technical requirement curve for high voltage ride-through of a wind turbine generator system is shown: when voltages of grid connection points in the wind turbine generator system are U_{N}≤1.10 p.u., it can operate continuously; when 1.10 p.u.<U_{N}≤1.15 p.u., it can operate continuously for 8 s without disconnecting from the grid; when 1.15 p.u.<U_{N}≤1.20 p.u., it can operate continuously for 2 s without disconnecting from the grid; when 1.20 p.u.<U_{N}≤1.25p.u., it can operate continuously for 1 s without disconnecting from the grid, when 1.25 p.u.<U_{N}≤1.30 p.u., it can operate continuously without disconnecting from the grid for 0.2 s; when U_{N}>1.30 pu. it is allowed to exit operation; during the HVRT process, if the inductive reactive power generated by the wind turbine generator system cannot suppress the increase in voltages of grid connection points under the condition of meeting the HVRT technical requirement curve, high-voltage grid disconnection will occur; large-scale grid disconnection of the wind turbine generator system will affect the stability of the power system; and in severe cases, it will cause the power system to be disconnected and cause large-scale power outages, seriously affecting people's lives. Therefore, fully tapping the reactive voltage regulation capability of wind farms is of great significance to enhancing the voltage stability of the power system.

The step 400 of determining whether the reactive power shortage of grid connection points is within wind farm regulation ranges and implement corresponding control strategies to adjust voltages based on the reactive power shortage specifically comprises:
determining whether the reactive power shortage of grid connection points under faults is less than a sum of reactive power limits of doubly-fed induction generators under constant active power outputs and reactive power limits of super capacitor-side converters, if so, implementing improved control strategies for energy storage systems to adjust voltages, if not, then utilizing static var generators to compensate for differences and adjust voltages, and re-determining whether there is a need to implement the coordinated control strategies.

A converter of a voltage-type SVG is connected in parallel to a power grid system through a reactor comprises a structure as shown in FIG. 5;
in FIG. 5: U_{svg}, L_{g}, I_{L}, and Uₛ are voltage amplitude vector of the SVG, reactance connected to the grid, current flowing to the grid, and amplitude vector of the grid voltage respectively; and
reactive power generated by the SVG during a fault in dq transformation is expressed as follows:

$${Q}_{svg} = - \frac{3}{2} {U}_{s} {I}_{svgq} , \qquad ( 4 )$$

where Q_{svg} and I_{svgq} are reactive power generated by the SVG and q-axis component of current flowing from the SVG to the grid, respectively, when a DC fault occurs and a system voltage suddenly rises, the reactive power response capability of SVG is strong and the reactive power response speed thereof is quite fast.

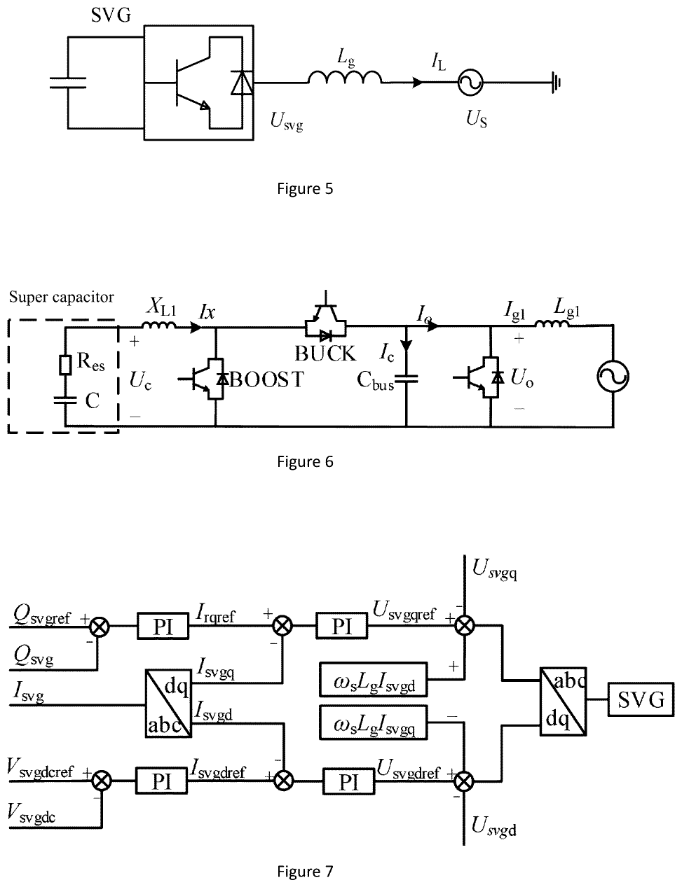

The energy storage system studied in the present invention is a super capacitor connected to the grid through a boost-buck circuit with a converter and a series reactor, as shown in FIG. 6;
energy storage capacity Eₛ of the super capacitor, remaining power|E_{c}(t) at time t, and state of charge S_{c}(t) are expressed as:

$$\{ \begin{matrix}{E}_{s} = \frac{1}{2} C ( {U}_{max}^{2} - {U}_{min}^{2} ) \\ {E}_{c} ( t ) = {\int }_{0}^{t} {η}_{c} {P}_{c} ( t ) dt \\ {S}_{c} ( t ) = \frac{{E}_{c} ( t )}{{E}_{s}} \times 100 \%\end{matrix} , \qquad ( 5 )$$

where Uₘₐₓ and Uₘᵢₙ are maximum and minimum operating voltages of the super capacitor, respectively; P_{c}(t) is charge and discharge power of the super capacitor at time t; η_{c} is charge and discharge efficiency of the super capacitor; and Eₛ is super capacitor capacity;
power and state of charge (SOC) constraints of energy storage are:

$$\{ \begin{matrix}{P}_{cmin} \leq {P}_{c} ( t ) \leq {P}_{cmax} \\ {S}_{cmin} \leq {S}_{c} ( t ) \leq {S}_{cmax}\end{matrix} , \qquad ( 6 )$$

where P_{cmin}, P_{cmax}, S_{cmin}, and S_{cmax} are minimum output power of the super capacitor, maximum output power of the super capacitor, minimum value of SOC and maximum value of SOC respectively, and in the present invention, S_{cmin} is taken as 20% and S_{cmax} is taken as 80%; and
if the loss of the converter itself is ignored, active power and reactive power exchanged between the grid and the converter under Direct-Quadrature-Zero (DQ0) transformation are as follows:
power and state of charge (SOC) constraints of energy storage are:

$$\{ \begin{matrix}{P}_{s} = \frac{3}{2} {U}_{S} {I}_{dc} \\ {Q}_{s} = - \frac{3}{2} {U}_{s} {I}_{qc}\end{matrix} , \qquad ( 7 )$$

where Pₛ, Qₛ, I_{dc}, and I_{qc} are active power, reactive power, and d-axis and q-axis components of the current flowing to the grid, respectively.

During the HVRT period, the energy storage system has a very fast static response speed in both active power leveling and reactive power regulation. Therefore, making full use of energy storage systems in wind farms can improve the reactive power support capacity of wind farms and effectively suppress voltage surge at grid connection points.

A control system of an SVG is shown in FIG. 7, in which: V_{svgdcref}, V_{svgdc}, Q_{svgref}, Q_{svg}, and I_{svg} are respectively voltage reference value of a DC capacitor of the SVG, voltage measured value of the DC capacitor of the SVG, reactive power reference value of the DC capacitor of the SVG, reactive power measured value of the DC capacitor of the SVG and current value flowing to SVG of the DC capacitor of the SVG; I_{svgqref}, I_{svgq}, I_{svgdref} and I_{svgd} are respectively reference value and measured value of q-axis component and reference value and measured value of d-axis component of current flowing to the SVG; ωₛ is grid angular frequency; L_{g} is equivalent inductive reactance of the converter connected to the grid.

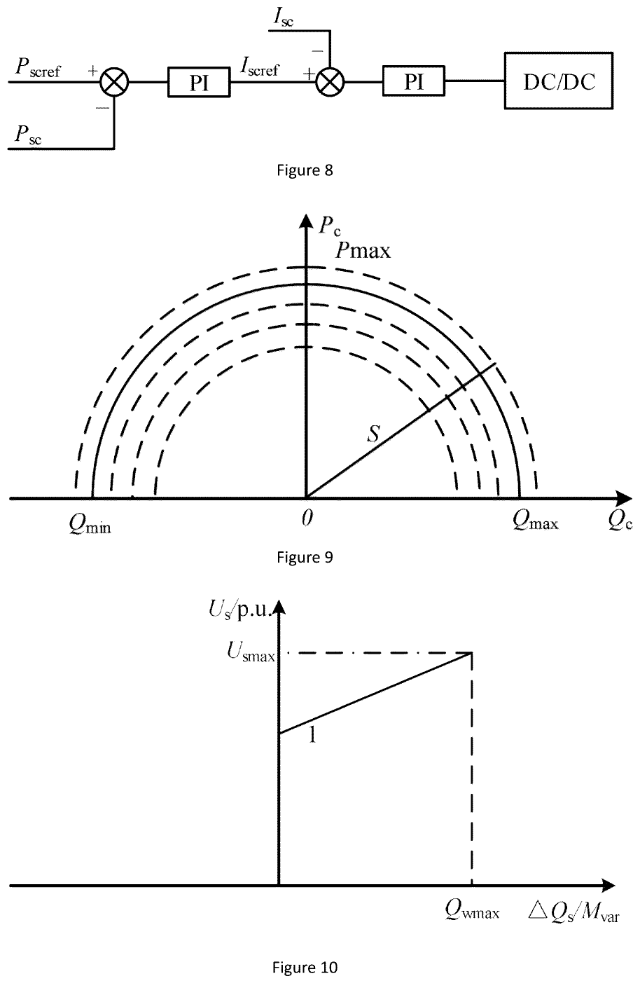

A control system diagram of a super capacitor is shown in FIG. 8, in which: P_{scref} is output power reference value of the super capacitor; P_{sc} is output power measured value of the super capacitor; is output current reference value of the super capacitor; I_{scref} is output current measured value of the super capacitor; during the HVRT period, the unbalanced active power of the grid is absorbed by adjusting P_{scref};
active and reactive current reference values, and active power and reactive power of grid-connected converter satisfy following constraints:

$$\{ \begin{matrix}\sqrt{{I}_{dcdref}^{2} + {I}_{dcqref}^{2}} \leq 1.2 {I}_{N} \\ {P}_{dcref}^{2} + {Q}_{dcref}^{2} \leq {S}^{2}\end{matrix} , \qquad ( 8 )$$

where, 1.2 I_{N} is long-term withstand current of an insulated gate bipolar transistor (IGBT) in a new energy storage grid-connected converter;
during the HVRT period, grid-connected voltage of new energy storage can be expressed as:

$$E = β {U}_{0} , \qquad ( 9 )$$

where β is proportional coefficient of voltage increasing; U₀ is grid voltage on a grid side under normal operation; and
from formulas (8) and (9), it can be seen that without considering the influence of the converter's long-term withstand current, PQ characteristic curve of converter output is a circle with zero as the center and S as the radius, as shown by the solid line in FIG. 9, due to the constraint of the long-term withstand current of the grid-connected converter, the change in the proportionality coefficient of grid-connected voltage increasing also affects PQ output of the grid-connected converter; considering the constraint of the long-term withstand current of the grid-side converter, PQ characteristic curve output is a curve family with the proportionality coefficient of grid-connected point voltage increasing, as shown in the dotted line in FIG. 9.

The super capacitor is divided into two operating stages, in the first stage, during steady-state operation, active power setting value of the super capacitor is equal to active power setting value of the converter under the constraints of ignoring the converter loss and satisfying formula (8) and formula (9); in the second stage, when a DC fault occurs in the grid, the grid voltage surges and the grid has a surplus of active power. P_{sref} is dynamically adjusted according to the principle of reactive power priority and active power suppression.

In order to make full use of the reactive power regulation capability of wind farms and give full play to the active power stabilization function of super capacitors, a voltage regulation range shown in FIG. 10 is designed according to reactive power reference values of a converter, wherein
Q_{wmax} is set as reactive power limit of a converter and Uₛₘₐₓ is set as upper limit of voltage regulation; and discount slope can be determined as:

$${K}_{w} = \frac{{U}_{smax} - 1}{{Q}_{wmax}} . \qquad ( 10 )$$

The improved control strategies comprise: dividing grid-tie inverters into following two operating modes: a first mode: during steady-state operation, high voltage ride-through modules take no action, active power output by super capacitors is equal to active power of converters when losses of converters are negligible, reference values of q-axis components of currents flowing from converters to grids are zero, and no reactive power exchange is performed with grids; and
a second mode: when a fault occurs, a high voltage ride-through operation mode is entered and works in an inductive reactive power compensation state, so that reactive power regulation capability of wind farms is utilized and active power stabilization function of super capacitors is leveraged, wherein active power setting values of super capacitors and converters are minimum values of maximum active power absorbed by systems, and reactive power reference values output from converters depend on reactive power regulation limits of wind farms.

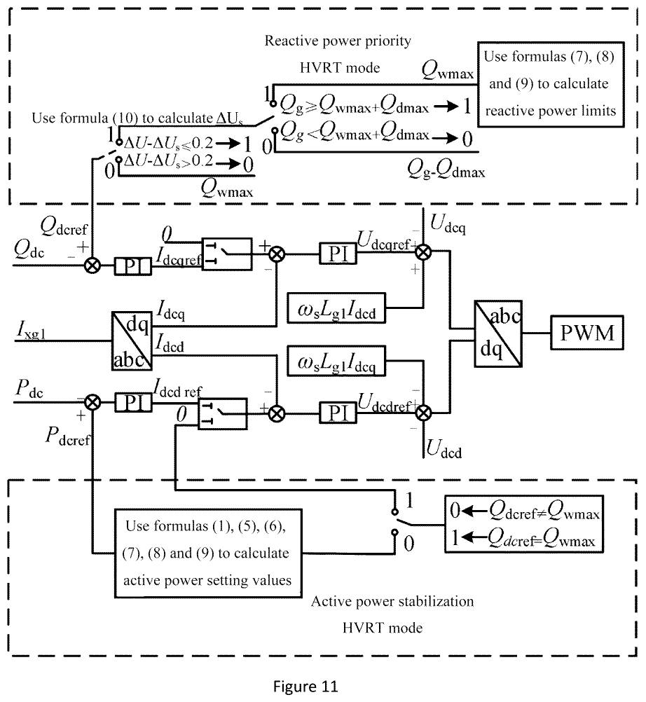

A control block diagram of the control strategy of reactive power priority and active power suppression for the energy storage system proposed by the present invention is shown in FIG. 11.

In FIG. 11: Q_{wmax} is reactive power limit output by a converter; Q_{dmax} is output reactive power limit when the active output of a DFIG remains unchanged; Q_{g} is reactive power required by a system; ΔUₛ is voltage regulation range; Q_{dcref} is reactive power reference value output by the converter; Q_{dc} is reactive power measured value output by the converter; P_{dcref} is voltage fluctuation of a grid connection point; L_{g1} is current measured value flowing from the converter to the grid; P_{dcref} is active power reference value output by the converter; P_{dc} is active power measured value output by the converter; I_{dcqref} is reference value of q-axis component of the current flowing from the converter to the grid; I_{dcq} is measured value of q-axis component of the current flowing from the converter to the grid; I_{dcdref} is reference value of the d-axis component of current flowing from the converter to the grid; I_{dcd} is measured value of d-axis component of current flowing from the converter to the grid;
the grid-tie inverters comprise two operating modes, the first mode is steady-state operation, an upper channel is selected, the HVRT module does not work, the active power emitted by the super capacitor and the active power of the converter are equal when the converter loss is ignored, I_{dcqref} is zero, and no reactive power exchange is performed with the grid; the second mode is HVRT mode, when the grid-side voltage surges, it first affects the new energy storage grid-connected converter, at this time, the grid-connected converter needs to output a certain amount of inductive reactive power to cooperate with DFIG and SVG to improve the HVRT capability of the wind farm, at this time, a lower channel is selected to enter the HVRT operation mode and work in the inductive reactive power compensation state; and
when the system demand is greater than or equal to the reactive power regulation limit of the wind farm, Q_{dcref} is Q_{wmax}, and I_{dcdref} is zero to select the lower channel; when the system demand is less than the reactive power regulation limit of the wind farm, in order to fully utilize the reactive power regulation capability of the wind farm and give play to the active power stabilization function of the super capacitor, if ΔU≤0.2, Q_{dcref} is reactively regulated according to the difference between Q_{g}−Q_{dmax}; according to formulas (7), (8), and (9), the maximum limit of the system active power that the converter can absorb is obtained, and then according to formulas (5) and (6), the maximum limit of the active power that the super capacitor can absorb is obtained, and the minimum value of the two is taken as the active power setting value of the super capacitor and the converter; if ΔU>0.2, Q_{dcref} is performed reactive power setting according to Q_{wmax}.

The step 500 of determining whether to utilize static var generators to compensate reactive power based on reactive power compensation of doubly-fed induction generators according to deviations between adjusted voltages and steady-state values, specifically comprises:
calculating absolute values of differences between real-time measured voltages of grid connection points and steady-state voltages of grid connection points, and determining whether the absolute values of differences are greater than 0.2, if not, using doubly-fed induction generators to compensate for differences in reactive power, if yes, first using the static var generators to compensate until the absolute values of differences between real-time measured voltages of grid connection points and steady-state voltages of grid connection points are less than or equal to 0.2, and then using doubly-fed induction generators to compensate for differences in reactive power.

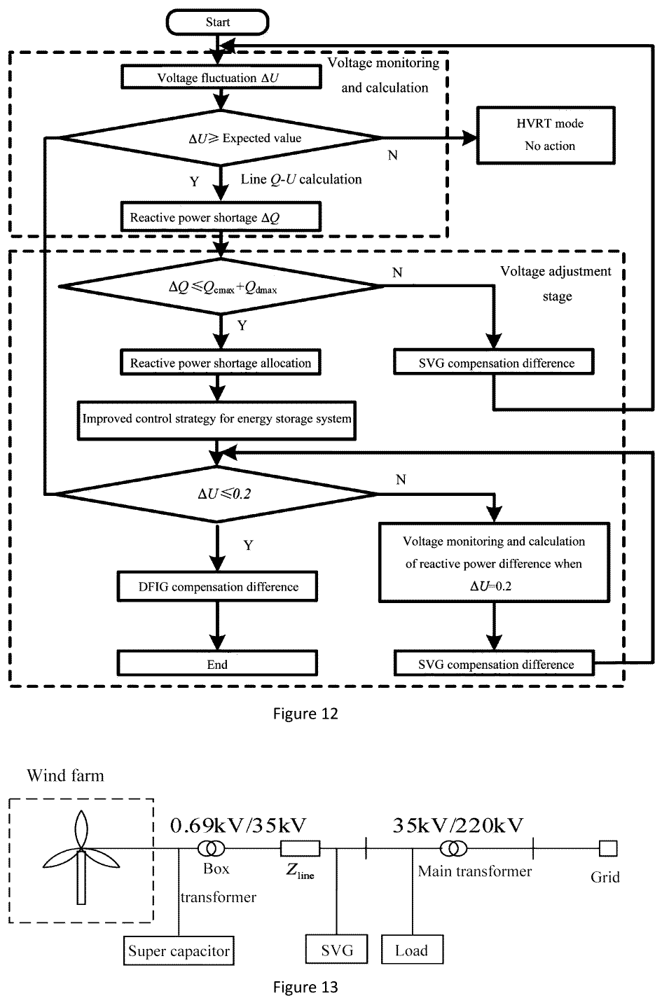

In order to improve the reactive voltage regulation capability of wind farms and active support capability for grid voltage thereof, and to greatly reduce the compensation burden of SVG, the present invention uses an improved collaborative control strategy, which is decomposed into reactive control of energy storage system, reactive control of RSC, reactive control of GSC, and reactive control of SVG according to priority, and a schematic diagram of the coordinated control strategy thereof is shown in FIG. 12, where: ΔU is voltage fluctuation of grid connection point; ΔQ is reactive power shortage of the system; and Q_{cmax} is reactive power limit of super capacitor-side converter.

The specific steps in FIG. 12 are as follows:
1. real-time monitoring voltage of grid connection point of wind farm, determining whether a current voltage is within a predetermined expected range, and entering a voltage adjustment stage if the current voltage exceeds the predetermined expected range;
2. if the current voltage is within the predetermined expected range, not operating static var generator;
3. if the current voltage exceeds the predetermined expected range, calculating reactive power to be compensated through the line Q-U; and
4. comparing with the reactive power regulation limit inside the wind farm, a first case: within a wind farm's own regulation range, entering an improved energy storage system control strategy, through the grid connection point monitoring and calculation, if ΔU≤0.2, DFIG performs reactive power shortage compensation; if ΔU>0.2, SVG compensates to ΔU=0.2 and then exits operation, DFIG performs reactive power shortage compensation; the second case: beyond the wind farm's own regulation range, SVG compensates to meet the first case and then executes case one.

The present invention provides an embodiment for verification, and a simulation model is built on the MATLAB/Simulink platform, and a system wiring diagram thereof is shown in FIG. 13, the DFIG simulation parameters are shown in Table 1, and the SVG and super capacitor system parameters are shown in Table 2;

TABLE 1
DFIG simulation parameters:

| Component | Parameter | Value |
|---|---|---|
| Wind turbine | Rated wind speed v/(m/s) | 13 |
| | Impeller radius R/m | 38 |
| | Air density ρ/(g/m) | 1.25 |
| Power generator | Rated power P/MW | 2.5 |
| | Rated voltage U/N | 690 |
| | Stator resistance Rs/p.u. | 0.0059 |
| | Stator leakage reactance | 0.257 |
| | Ls/p.u. | |
| | Rotor resistance Rr/p.u. | 0.0058 |
| | Rotor leakage reactance | 0.0895 |
| | Lr/p.u. | |
| | Magnetic reactance Lm/p.u. | 3.9653 |
| Converter | Grid-side rated capacity | 0.75 |
| | P_{GSC}/MVA | |
| | Generator-side rated capacity | 0.45 |
| | P_{RSC}/MVA | |
| Transformer | Box transformer ratio/kV | 0.69/35 |
| | Main transformer ratio/kV | 35/230 |

TABLE 2
SVG and super capacitor system parameters

| Component | Parameter | Value |
|---|---|---|
| SVG | Rated capacity (MVA) | 2 |
| | Rated voltage U/kV | 35 |
| Super Capacitor | Rated capacity (kVA) | 25 |
| | SOC range | 20%-80% |
| | Maximum operating voltage (V) | 400 |
| | Minimum operating voltage (V) | 300 |
| | Maximum operating current (A) | 60 |

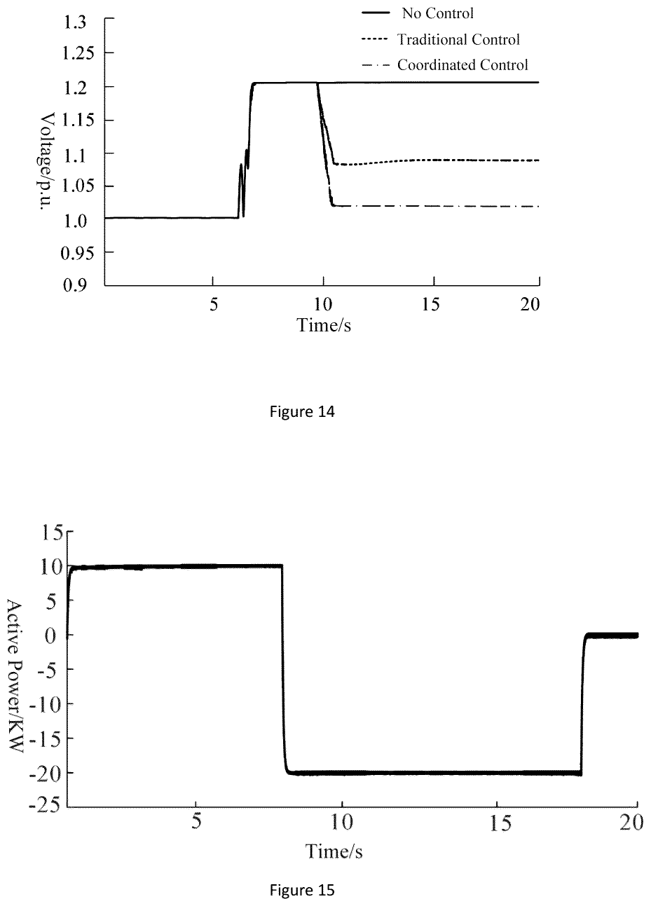

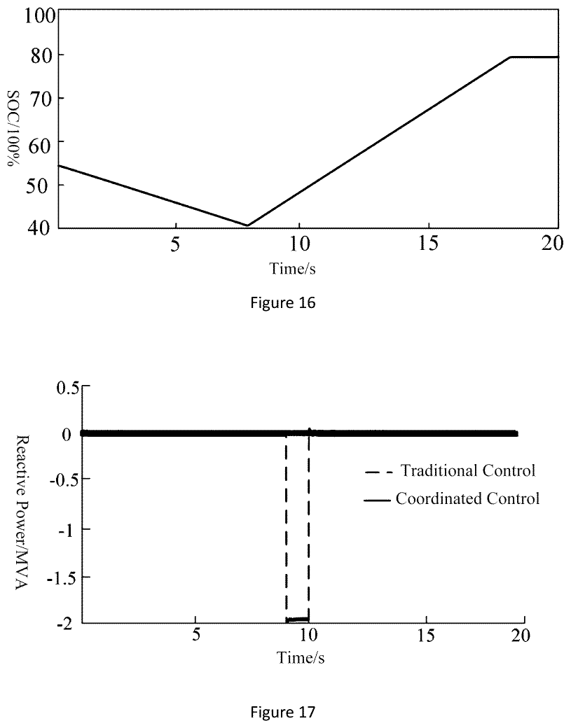

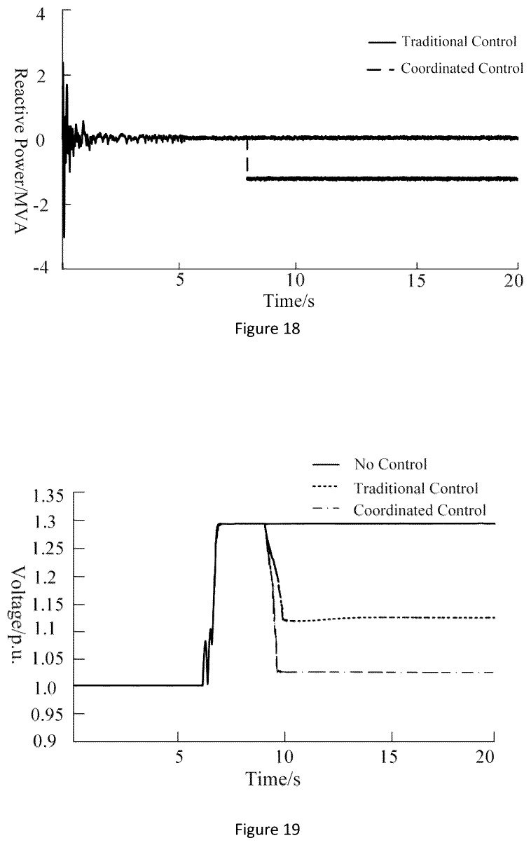

Working condition 1: Simulating a situation where the voltage surge at the grid connection point is small, as shown in FIG. 14, a DC fault occurs at 8 seconds, and the voltage at the grid connection point surges to 1.22 p.u., the first curve is a voltage curve without any control; the second curve is a voltage curve with the addition of a traditional control strategy, and the voltage drops to 1.07 p.u.; the third curve is a voltage curve with the cooperative control strategy of the present invention, and the voltage drops to 1.02 p.u.;
FIGS. 15-16 are the active power change curve and SOC change curve of the super capacitor, respectively, which can be seen from the figure that under normal operation, the super capacitor only exchanges active power with the grid, after the voltage at the grid connection point suddenly rises due to a DC fault, the reactive power meets the requirements and performs active power stabilization to absorb the
excess active power of the grid, and it stops running after reaching SOCₘₐₓ;
FIGS. 17-18 are reactive power change curves of SVG and DFIG respectively. As shown in FIG. 17, in the traditional control, SVG reaches the full power state, while DFIG does not participate in reactive power regulation. By adopting the coordinated control strategy of the present invention, DFIG enters the full power state without affecting the active power output, and SVG no longer participates in reactive power regulation; and
as shown in FIG. 14-18, after a DC fault, the voltage is reduced to 1.07 p.u. by the traditional control strategy, the SVG reaches the full power state, and the DFIG does not participate in reactive power regulation; the voltage is reduced to 1.02 p.u. by the coordinated control strategy of the present invention, and the energy storage system absorbs the surplus active power of the system after satisfying reactive power priority, the DFIG reaches the full power state without affecting the active power output, and the SVG does not need to act.

Working condition 2: Simulating a situation where the voltage surge at the grid connection point is large, as shown in FIG. 18, a DC fault occurs at 8 seconds, and the voltage at the grid connection point rises sharply to 1.3 p.u., the first curve is a voltage change curve without any control strategy; the second curve is a traditional control strategy where the voltage is reduced to 1.12 p.u., which does not meet the HVRT standard curve; the third curve is a coordinated control strategy of the present invention where the voltage is reduced to 1.02 p.u.;
when the voltage surge of grid connection point degree is large, the voltage detection curve of grid connection points is shown in FIG. 19;
FIG. 20 is the reactive power change curve of SVG, which can be seen from the figure that with the traditional control strategy, SVG reaches the full power state; however, with the collaborative control strategy, SVG reserves half of the reactive power margin; and
FIGS. 21-22 show the SOC change curve and active power change curve of the super capacitors, which can be seen from the figure that during the HVRT period, the energy storage system uses the setting principle of reactive power priority and active power suppression. At 9 s, the inductive reactive power is emitted to the maximum extent to suppress the voltage increasing at the grid connection point, and the active power setting value is 0. After reactive power regulation, active power suppression is immediately performed to absorb excess active power of the system, and the system stops running when SOCₘₐₓ is reached.

In view of the problem that the weak high voltage HVRT ride-through capability of wind power will cause large-scale wind turbine generators to be disconnected from the grid, embodiments of the present invention propose a wind farm internal reactive power regulation (energy storage system, DFIG) and SVG coordinated control strategy to improve the reactive power support capability of the wind farm, and draws the following conclusions:
1. Based on the operating characteristic equations of DFIG, the internal mechanism of wind turbine disconnection caused by DC faults is elaborated in detail, and the dynamic response characteristics of energy storage systems and SVGs during HVRT are analyzed. Based on the above theoretical analysis, the coordinated control strategy of wind farm internal reactive power regulation (energy storage system, DFIG) and SVG improvement can effectively suppress the voltage surge at the grid connection points, greatly reduce the compensation burden of SVGs and solve the problem of active power surplus of the grid to a certain extent.
2. If the voltage surge at the grid connection points is small, the coordinated control strategy can maintain the voltage at the grid connection point within the expected range only through reactive power regulation within the wind farm, and SVGs do not need to participate in reactive power regulation; if the voltage surge at the grid connection points is large and the reactive power regulation within the wind farms cannot meet the HVRT technical requirements, the coordinated control strategy maintains the voltage at the grid connection point within the expected range through the coordinated and orderly actions of energy storage systems, DFIGs and SVGs.
3. The feasibility of the control strategy proposed in the present embodiment is verified through simulation, which provides a new idea for fully tapping the reactive power regulation capability of the wind farms themselves and greatly reducing the reactive power compensation burden of SVGs, and has certain theoretical reference and practical application prospects.

The high voltage ride-through method for wind power based on coordinated control of energy storage and reactive compensation devices provided by the present invention comprises: fault determination based on voltages of grid connection points of wind farms; setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults; calculating reactive power shortage of grid connection points under faults based on the control strategies; determining whether the reactive power shortage of grid connection points is within wind farm regulation ranges and implement corresponding control strategies to adjust voltages based on the reactive power shortage; and determining whether to utilize static var generators to compensate reactive power based on reactive power compensation of doubly-fed induction generators according to deviations between adjusted voltages and steady-state values. The method of the present invention makes full use of the active power leveling capability of energy storage systems while considering the coordinated control capability after integrating reactive compensation devices, so as to enhance the high voltage ride-through capability of wind farms.

The present invention uses specific examples to illustrate the principles and implementation methods of the present invention. The above examples are only used to help understand the method and core ideas of the present invention. At the same time, for those skilled in the art, according to the ideas of the present invention, there will be changes in the specific implementation methods and application scope. In summary, the content of this specification should not be understood as limiting the present invention.

1. A high voltage ride-through method for wind power based on coordinated control of energy storage and reactive compensation devices, comprising following steps:
step 100: fault determination based on voltages of grid connection points of wind farms;
step 200: setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults;
step 300: calculating reactive power shortage of grid connection points under faults based on the control strategies;
step 400: determining whether the reactive power shortage of grid connection points is within wind farm regulation ranges and implement corresponding control strategies to adjust voltages based on the reactive power shortage; and
step 500: determining whether to utilize static var generators to compensate reactive power based on reactive power compensation of doubly-fed induction generators according to deviations between adjusted voltages and steady-state values.

2. The high voltage ride-through method for wind power based on coordinated control of energy storage and reactive compensation devices according to claim 1, wherein the step 200 of setting voltage fluctuation thresholds of grid connection points under faults, and determining whether to implement super capacitor, doubly-fed induction generator, and static var generator coordinated control strategies based on voltage fluctuation thresholds of grid connection points of commutation bus voltages under faults, specifically comprises:
setting voltage fluctuation thresholds of grid connection points under faults, and determining whether grid connection point voltages under faults are greater than the voltage fluctuation thresholds, if so, implementing coordinated control strategies, and if not, not implementing coordinated control strategies.

3. The high voltage ride-through method for wind power based on coordinated control of energy storage and reactive compensation devices according to claim 2, wherein the step 400 of determining whether the reactive power shortage of grid connection points is within wind farm regulation ranges and implement corresponding control strategies to adjust voltages based on the reactive power shortage, specifically comprising:
determining whether the reactive power shortage of grid connection points under faults is less than a sum of reactive power limits of doubly-fed induction generators under constant active power outputs and reactive power limits of super capacitor-side converters, if so, implementing improved control strategies for energy storage systems to adjust voltages; if not, then utilizing static var generators to compensate for differences and adjust voltages, and re-determining whether there is a need to implement the coordinated control strategies.

4. The high voltage ride-through method for wind power based on coordinated control of energy storage and reactive compensation devices according to claim 3, wherein the improved control strategies comprise: dividing grid-tie inverters into following two operating modes: a first mode: during steady-state operation, high voltage ride-through modules take no action, active power output by super capacitors is equal to active power of converters when losses of converters are negligible, reference values of q-axis components of currents flowing from converters to grids are zero, and no reactive power exchange is performed with grids; and
a second mode: when a fault occurs, a high voltage ride-through operation mode is entered and works in an inductive reactive power compensation state, so that reactive power regulation capability of wind farms is utilized and active power stabilization function of super capacitors are leveraged, wherein active power setting values of super capacitors and converters are minimum values of maximum active power absorbed by systems, and reactive power reference values output from converters depend on reactive power regulation limits of wind farms.

5. The high voltage ride-through method for wind power based on coordinated control of energy storage and reactive compensation devices according to claim 4, wherein the step 500 of determining whether to utilize static var generators to compensate reactive power based on reactive power compensation of doubly-fed induction generators according to deviations between adjusted voltages and steady-state values, specifically comprises:
calculating absolute values of differences between real-time measured voltages of grid connection points and steady-state voltages of grid connection points, and
determining whether the absolute values of differences are greater than 0.2, if not, using doubly-fed induction generators to compensate for differences in reactive power, if yes, first using the static var generators to compensate until the absolute values of differences between real-time measured voltages of grid connection points and steady-state voltages of grid connection points are less than or equal to 0.2, and then using doubly-fed induction generators to compensate for differences in reactive power.
